(19) United States
(12) Patent Application Publication
(10) Pub. No.: US 2016/0202816 A1
(43) Pub. Date: Jul. 14, 2016

(54) FLEXIBLE TOUCH PANEL AND FLEXIBLE DISPLAY DEVICE

(71) Applicant: Samsung Display Co., Ltd., Yongin-city (KR)

(72) Inventor: Jung Mok PARK, Hwaseong-si (KR)

(21) Appl. No.: 14/806,765

(22) Filed: Jul. 23, 2015

(30) Foreign Application Priority Data
Jan. 9, 2015 (KR) 10-2015-0003502

(51) Int. Cl. G06F 3/041; G06F 1/16

(52) U.S. Cl. CPC G06F 3/0412; G06F 1/1652; G06F 1/1643; G06F 2203/04102

(57) ABSTRACT

A flexible touch panel includes a flexible substrate, and a touch sensor unit disposed on the flexible substrate, the touch sensor including a transparent conductive oxide layer and a transparent metal layer laminated to contact each other.

### CROSS-REFERENCE TO RELATED APPLICATION

This application claims priority from and the benefit of Korean Patent Application No. 10-2015-0003502, filed on Jan. 9, 2015, which is hereby incorporated by reference for all purposes as if fully set forth herein.

### BACKGROUND

1. Field

Exemplary embodiments of the present invention relate to a flexible touch panel and a flexible display device.

2. Discussion of the Background

A touch panel may recognize a touch of a pen or a user's finger, and the touch panel may be disposed on a display panel, such as an organic light emitting diode display and a liquid crystal display. The touch panel may be a means for inputting a signal to display device.

The touch panel includes a substrate and a touch sensor unit disposed on the substrate to recognize a touch. The substrate may be formed of a flexible film, and a touch sensor unit may be formed of metal mesh or silver nanowire (AgNW). A touch panel that may be entirely flexible has been studied.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments of the present invention provide a flexible touch panel and a flexible display device including a touch sensor unit that may suppress damage thereof from external stress and delay of a signal.

Additional aspects will be set forth in the detailed description which follows, and, in part, will be apparent from the disclosure, or may be learned by practice of the inventive concept.

According to an exemplary embodiment of the present invention, a flexible touch panel includes a flexible substrate, and a touch sensor unit disposed on the flexible substrate, the touch sensor including a transparent conductive oxide layer and a transparent metal layer laminated to contact each other.

The transparent metal layer may include metal mesh.

The transparent metal layer may include silver nanowire (AgNW).

The touch sensor unit may include first touch pad parts disposed on the flexible substrate, the first touch pad parts spaced apart from each other in a first direction, a first connection part connecting the first touch pad parts, second touch pad parts disposed on the flexible substrate, the second touch pad parts spaced apart from each other in a second direction crossing the first direction, a second connection part connecting the second touch pad parts, and in insulation layer disposed between and separating the first connection part and the second connection part.

The first touch pad parts and the first connection part may be integrally formed.

The second touch pad parts may be formed on the same layer as the first touch pad parts.

A second touch pad part may include a first transparent metal layer disposed on the flexible substrate and a first transparent conductive oxide layer disposed on the first transparent metal layer, and the second connection part may include a second transparent metal layer contacting the first transparent conductive oxide layer.

A second touch pad part may include a first transparent conductive oxide layer disposed on the flexible substrate and a first transparent metal layer disposed on a first transparent conductive oxide layer, and the second connection part may include a second transparent metal layer contacting the first transparent metal layer.

A second touch pad part may include a first transparent metal layer disposed on the flexible substrate, and the second connection part may include a first transparent conductive oxide layer contacting the first transparent metal layer and a second transparent metal layer disposed on the first transparent conductive oxide layer.

A second touch pad part may include a first transparent metal layer disposed on the flexible substrate, and the second connection part may include a second transparent metal layer contacting the first transparent metal layer and a first transparent conductive oxide layer disposed on the second transparent metal layer.

The insulating layer may be disposed on the second connection part, a second touch pad part may include a first transparent metal layer disposed on the flexible substrate, and the second connection part may include a second transparent metal layer contacting the first transparent metal layer and a first transparent conductive oxide layer disposed on the second transparent metal layer.

According to an exemplary embodiment of the present invention, a flexible display device includes a flexible display panel configured to display an image, and a touch sensor unit disposed on the flexible display panel, the touch sensor unit including a transparent conductive oxide layer and a transparent metal layer laminated to contact each other.

A first touch pad part and the first connection part may include a third transparent metal layer and a second transparent conductive oxide layer disposed on the third transparent metal layer, and the first connection part may be spaced apart from the second touch pad part by the insulation layer.

A first touch pad part and the first connection part may include a second transparent conductive oxide layer and a third transparent metal layer disposed on the second transparent conductive oxide layer, and the first connection part may be spaced apart from the second touch pad part by the insulation layer.

A first touch pad part and the first connection part may include a third transparent metal layer disposed on the flexible substrate, and the first connection part may be spaced apart from the second touch pad part by the insulation layer.

A first touch pad and the first connection part may include a third transparent metal layer disposed on the insulating layer, and a first distance from the flexible substrate to an upper surface of the third transparent metal layer may be greater than a second distance from the flexible substrate to an upper surface of the first transparent metal layer, so that the third transparent metal layer may not contact the first transparent metal layer.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a plan view illustrating a flexible touch panel according to an exemplary embodiment of the present invention.

FIG. 2 is a cross-sectional view of FIG. 1 taken along line II-II.

FIG. 3 is a cross-sectional view illustrating a part of a flexible touch panel according to an exemplary embodiment of the present invention.

FIG. 4 is a cross-sectional view illustrating a part of a flexible touch panel according to an exemplary embodiment of the present invention.

FIG. 5 is a cross-sectional view illustrating a part of a flexible touch panel according to an exemplary embodiment of the present invention.

FIG. 6 is a cross-sectional view illustrating a part of a flexible touch panel according to an exemplary embodiment of the present invention.

FIG. 7 is a cross-sectional view illustrating a part of a flexible display device according to an exemplary embodiment of the present invention.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

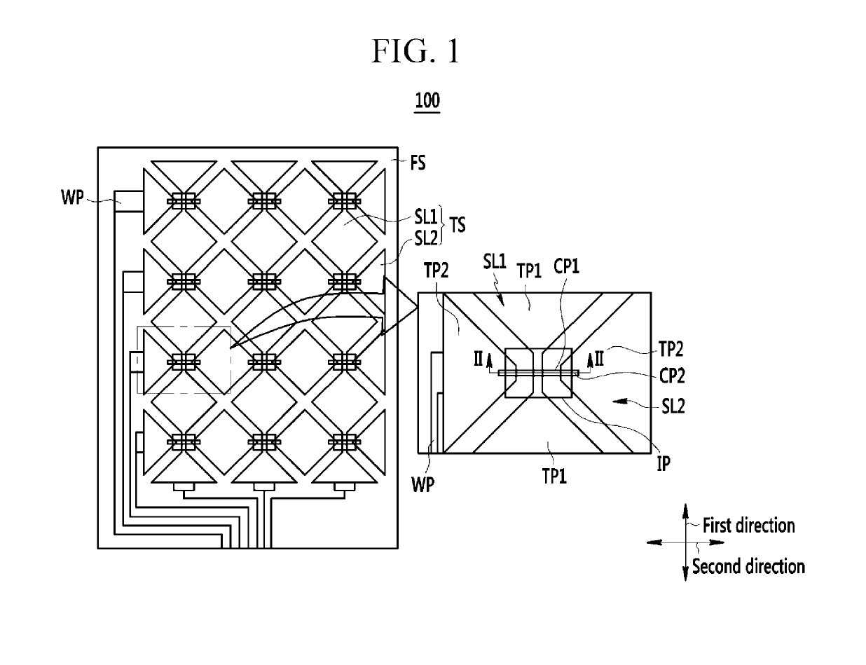

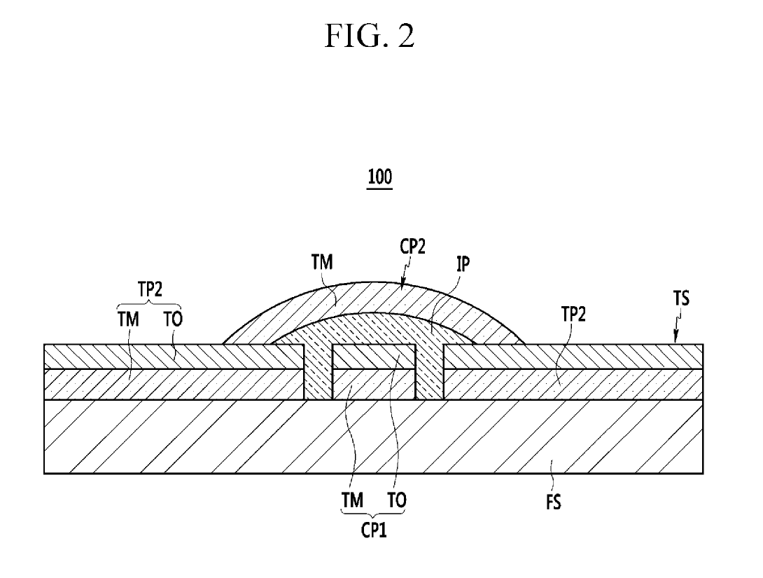

FIG. 1 is a plan view illustrating a flexible touch panel according to an exemplary embodiment of the present invention. FIG. 2 is a cross-sectional view of FIG. 1 taken along line II-II.

As illustrated in FIGS. 1 and 2, a flexible touch panel 100 according to the present exemplary embodiment may recognize a touch and include a flexible substrate FS, a wire part WP, and a touch sensor unit TS. The flexible touch panel 100 may include a touch controller (not illustrated), and the touch controller may be formed to connect a flexible printed circuit board or a printed circuit board to the wire part WP. The touch controller may calculate information on a position touched by a user by digitizing an electric analog signal transmitted from the flexible touch panel 100 to a digital signal through a converter and the like.

The flexible substrate FS is flexible and may include a flexible film. The flexible substrate FS is an insulation substrate including polymer, glass, stainless steel, or the like. The flexible substrate FS may also be stretchable, foldable, bendable, or rollable, so that the entire flexible touch panel 100 may be flexible, stretchable, foldable, bendable, or rollable.

The wire part WP may be disposed in an outer region of the flexible substrate FS and connected to the touch sensor unit TS. The wire part WP may connect the touch sensor unit TS and the touch controller to each other, and may include an opaque conductive material such as metal or a transparent conductive material. The wire part WP may be formed on the flexible substrate FS by using a different process or the same process as the touch sensor unit TS.

The touch sensor unit TS may recognize the touch and be transparent. The touch sensor unit TS is disposed on the flexible substrate FS to be formed as a capacitive type. The touch sensor unit TS includes a first signal line SL1 extending in a first direction on the flexible substrate FS to be connected to the wire part WP, and a second signal line SL2 extending in a second direction crossing the first direction to be connected to the wire part WP.

First signal lines SL1 may be sequentially disposed in the second direction. The second signal lines SL2 may be sequentially disposed in the first direction. The first signal line SL1 and the second signal line SL2 cross each other, and at a portion where the first signal line SL1 and the second signal line SL2 cross each other, an insulating layer IP is disposed between the first signal line SL1 and the second signal line SL2, so that the first signal line SL1 and the second signal line SL2 cross each other while being insulated from each other. The insulating layer IP may be formed in a pattern form and may include a silicon oxide (SiOx), silicon nitride (SiNx), or the like.

In the flexible touch panel 100, when voltages are sequentially applied to the first signal lines SL1 and the second signal lines SL2 to charge the charges in the first signal lines SL1 and the second signal lines SL2, respectively, and when the first signal lines SL1 or second signal lines SL2 are touched, a capacitance of the touched first signal lines SL1 or second signal lines SL2 may be changed, so that a touched position may be determined.

The first signal line SL1 includes first touch pad parts TP1 and a first connection part CP1. The first touch pad parts TP1 may be spaced apart from each other in the first direction. The first connection part CP1 connects the first touch pad parts TP1 to each other, and particularly, connects adjacent first touch pad parts TP1 to each other. The first touch pad part TP1 and the first connection part CP1 are integrally formed, and include a transparent conductive oxide layer TO and a transparent metal layer TM which are laminated to contact each other. That is, the transparent conductive oxide layer TO is laminated to completely cover the transparent metal layer TM. And, in another exemplary embodiment, transparent conductive oxide layer TO and a transparent metal layer TM which are deposited to contact each other.

The transparent conductive oxide layer TO includes a light-transmissive conductive oxide material such as indium tin oxide (ITO) or indium zinc oxide (IZO). The transparent metal layer TM is a transparent conductive layer including metal, and includes metal mesh or silver nanowire (AgNW). The metal mesh may be a metal pattern layer having a mesh shape in which openings are formed, and the metal mesh may include openings having any shape. For example, the openings have Triangular shape, Rectangular shape, Pentagonal shape, Hexagonal shape, Heptagon shape, Polygonal shape, Circular shape, Oval shape, or Closed loop shape. Further, silver nanowire may be dispersed inside a base layer including resin and the like, and the transparent metal layer TM may include silver nanowire and base layer.

Each of the first touch pad part TP1 and the first connection part CP1 includes a transparent metal layer TM disposed on the flexible substrate FS and a transparent conductive oxide layer TO disposed on the transparent metal layer TM to contact the transparent metal layer TM.

The second signal line SL2 includes second touch pad parts TP2 and a second connection part CP2. The second touch pad parts TP2 may be spaced apart from each other in the second direction. The second connection part CP2 connects the second touch pad parts TP2 to each other, and particularly, connects adjacent second touch pad parts TP2 to each other. The second touch pad part TP2 and the second connection part CP2 are formed on different layers. The second connection part CP2 has a bridge shape and connects the adjacent second touch pad parts TP2. The second connection part CP2 is spaced apart from the first connection part CP1 by the insulating layer IP to connect the adjacent second touch pad parts TP2.

The second touch pad part TP2 is formed on the same layer and includes the same material as the first touch pad part TP1 and the first connection part CP1, and may be simultaneously formed with the first touch pad part TP1 and the first connection part CP1. The second touch pad part TP2 includes a transparent metal layer TM disposed on the flexible substrate FS and a transparent conductive oxide layer TO disposed on the transparent metal layer TM to contact the transparent metal layer TM.

The second connection part CP2 is spaced apart from the first connection part CP1 with the insulating layer IP disposed therebetween. More particularly, the second connection part CP2 is disposed on the first connection part CP1 with the insulating layer IP disposed therebetween. The second connection part CP2 includes a transparent metal layer TM which contacts a transparent conductive oxide layer TO disposed on the uppermost layer of the second touch pad part TP2. The transparent metal layer TM of the second connection part CP2 includes metal mesh or silver nanowire, and the transparent metal layer TM of the second connection part CP2 contacts the transparent conductive oxide layer TO having a plate shape, and accordingly, portions of the metal mesh or silver nanowires contact the transparent conductive oxide layer TO. As a result, contact resistance between the second connection part CP2 and the second touch pad part TP2 may be minimized.

As described above, the flexible touch panel 100 according to the present exemplary embodiment includes the flexible substrate FS, and each of the first touch pad part TP1 of the touch sensor unit TS, the first connection part CP1, the second touch pad part TP2, and the second connection part CP2 includes the transparent metal layer TM including metal mesh or silver nanowire to improve flexibility.

Further, in the flexible touch panel 100 according to the present exemplary embodiment, each of the first touch pad part TP1, the first connection part CP1, the second touch pad part TP2, and the second connection part CP2 includes the transparent metal layer TM including metal mesh or silver nanowire. As a result, when a stress is applied to the flexible touch panel 100 from bending the flexible touch panel 100, since metal mesh or silver nanowire may be easily bent by the stress so as to distribute the stress in the transparent metal layer TM, the touch sensor unit TS may be suppressed from being damaged by the stress even though each of the first touch pad part TP1, the first connection part CP1, and the second touch pad part TP2 includes the transparent conductive oxide layer TO that has a higher brittleness than the transparent metal layer TM.

Further, in the flexible touch panel 100 according to the present exemplary embodiment, the second connection part CP2 includes the transparent metal layer TM including metal mesh or silver nanowire that point-contacts another contact member, but the second touch pad part TP2 contacting the second connection part CP2 includes the transparent conductive oxide layer TO having a plate shape. As a result, since the portions of the metal mesh of the transparent metal layer TM of the second connection part CP2 or the silver nanowires contact the transparent conductive oxide layer TO of the second touch pad part TP2, the second connection part CP2 and the second touch pad part TP2 surface-contact each other to minimize contact resistance between the second connection part CP2 and the second touch pad part TP2. Accordingly, the flexible touch panel 100 may suppress a delay in a signal passing through the touch sensor unit TS.

Further, in the flexible touch panel 100 according to the present exemplary embodiment ion, each of the first touch pad part TP1, the first connection part CP1, the second touch pad part TP2, and the second connection part CP2 includes the transparent metal layer TM including metal mesh or silver nanowire, and as a result, the touch sensor unit TS may not be observed.

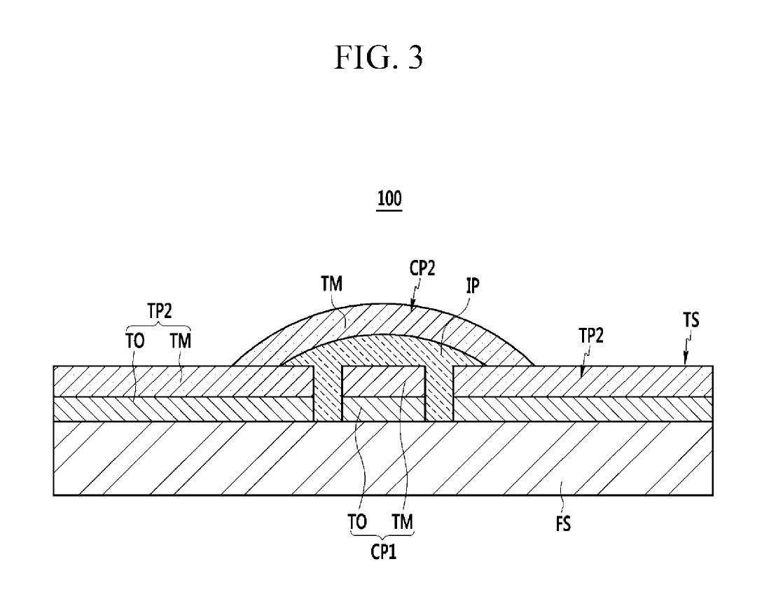

Hereinafter, a flexible touch panel according to an exemplary embodiment of the present invention will be described with reference to FIG. 3. The flexible touch panel illustrated in FIG. 3 may have substantially the same elements as the flexible touch panel illustrated with reference to FIG. 2, and accordingly, repeated description thereof will be omitted.

FIG. 3 is a cross-sectional view illustrating a part of a flexible touch panel according to an exemplary embodiment of the present invention.

As illustrated in FIG. 3, in a flexible touch panel 100 according to the present exemplary embodiment, a second touch pad part TP2 is formed on the same layer and includes the same material as a first touch pad part and a first connection part CP1, and may be simultaneously formed with the first touch pad part and the first connection part CP1. The second touch pad part TP2 includes a transparent conductive oxide layer TO disposed on the flexible substrate FS and a transparent metal layer TM disposed on the transparent conductive oxide layer TO, to contact the transparent conductive oxide layer TO.

The second connection part CP2 is spaced apart from the first connection part CP1 with the insulating layer IP disposed therebetween. More particularly, the second connection part CP2 is disposed on the first connection part CP1 with the insulating layer IP disposed therebetween. The second connection part CP2 includes a transparent metal layer TM which contacts the transparent metal layer TM disposed on the uppermost layer of the second touch pad part TP2.

As described above, the flexible touch panel 100 according to the present exemplary embodiment includes the flexible substrate FS, and each of the first touch pad part of the touch sensor unit TS, the first connection part CP1, the second touch pad part TP2, and the second connection part CP2 in the flexible touch panel 100 includes the transparent metal layer TM including metal mesh or silver nanowire to improve flexibility.

Further, in the flexible touch panel 100 according to the present exemplary embodiment, each of the first touch pad part, the first connection part CP1, the second touch pad part TP2, and the second connection part CP2 includes the transparent metal layer TM including metal mesh or silver nanowire. As a result, when a stress is applied to the flexible touch panel 100 from bending the flexible touch panel 100, since metal mesh or silver nanowire may be easily bent by the stress so as to distribute the stress in the transparent metal layer TM, the touch sensor unit TS may be suppressed from being damaged by the stress even though each of the first touch pad part, the first connection part CP1, and the second touch pad part TP2 includes the transparent conductive oxide layer TO that has a higher brittleness than the transparent metal layer TM.

Further, in the flexible touch panel 100 according to the present exemplary embodiment, each of the first touch pad part, the first connection part CP1, the second touch pad part TP2, and the second connection part CP2 includes the transparent metal layer TM including metal mesh or silver nanowire, and as a result, the touch sensor unit TS may not be observed.

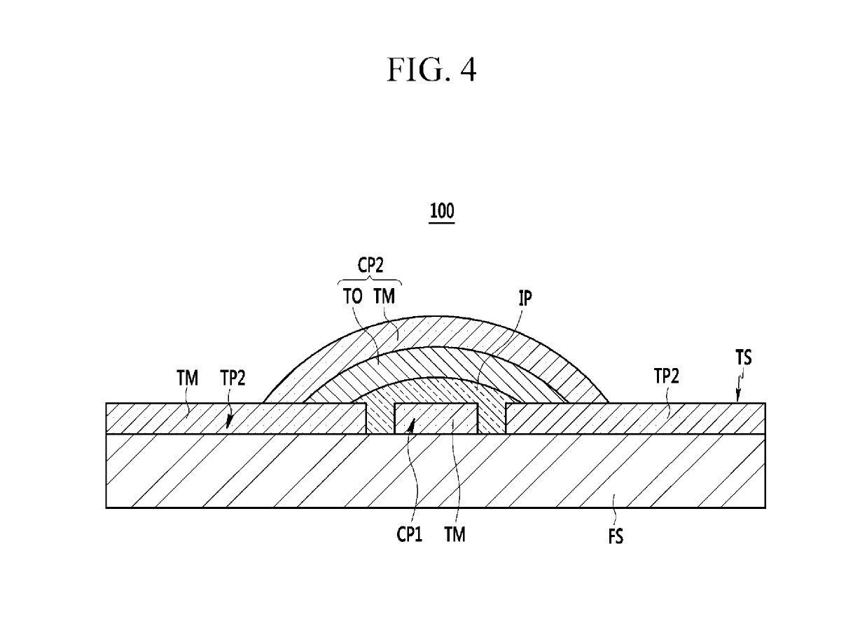

Hereinafter, a flexible touch panel according to an exemplary embodiment of the present invention will be described with reference to FIG. 4. FIG. 4 is a cross-sectional view illustrating a part of a flexible touch panel according to an exemplary embodiment of the present invention.

The second touch pad part TP2 is formed on the same layer and includes the same material as the first touch pad part TP1 and the first connection part CP1, and may be simultaneously formed with the first touch pad part TP1 and the first connection part CP1. The second touch pad part TP2 includes a transparent metal layer TM disposed on the flexible substrate FS.

The second connection part CP2 is spaced apart from the first connection part CP1 with the insulating layer IP disposed therebetween. More particularly, the second connection part CP2 is disposed on the first connection part CP1 with the insulating layer IP disposed therebetween.

The second connection part CP2 includes a transparent conductive oxide layer TO contacting the transparent metal layer TM disposed on the uppermost layer of the second touch pad part TP2, and a transparent metal layer TM disposed on the transparent conductive oxide layer TO, to contact the transparent conductive oxide layer TO. The transparent metal layer TM of the second touch pad part TP2 includes metal mesh or silver nanowire, but the transparent metal layer TM of the second touch pad part TP2 contacts the transparent conductive oxide layer TO having a plate shape of the second connection part CP2, and as a result, portions of the metal mesh of the second touch pad part TP2 or silver nanowires contact the transparent conductive oxide layer TO of the second connection part CP2. As a result, contact resistance between the second connection part CP2 and the second touch pad part TP2 may be minimized.

As described above, the flexible touch panel 100 according to the present exemplary embodiment includes the flexible substrate FS, and each of the first touch pad part of the touch sensor unit TS, the first connection part CP1, the second touch pad part TP2, and the second connection part CP2 in the flexible touch panel 100 includes the transparent metal layer TM including metal mesh or silver nanowire to improve flexibility.

Further, in the flexible touch panel 100 according to the present exemplary embodiment, each of the first touch pad part, the first connection part CP1, the second touch pad part TP2, and the second connection part CP2 includes the transparent metal layer TM including metal mesh or silver nanowire. As a result, when a stress is applied to the flexible touch panel 100 from bending the flexible touch panel 100, since metal mesh or silver nanowire may be easily bent by the stress so as to distribute the stress in the transparent metal layer TM, the touch sensor unit TS may be suppressed from being damaged by the stress even though each of the first touch pad part, the first connection part CP1, and the second touch pad part TP2 includes the transparent conductive oxide layer TO that has a higher brittleness than the transparent metal layer TM.

Further, in the flexible touch panel 100 according to the present exemplary embodiment, the second touch pad part TP2 includes the transparent metal layer TM including metal mesh or silver nanowire that point-contacts another contact member, but the second touch pad part TP2 contacting the second connection part CP2 includes the transparent conductive oxide layer TO having a plate shape. As a result, since portions of the metal mesh of the transparent metal layer TM of the second connection part CP2 or the silver nanowires contact the transparent conductive oxide layer TO of the second connection part CP2, the second connection part CP2 and the second touch pad part TP2 surface-contacts each other to minimize contact resistance between the second connection part CP2 and the second touch pad part TP2. Accordingly, the flexible touch panel 100 may suppress a delay of a signal passing through the touch sensor unit TS.

Further, in the flexible touch panel 100 according to the present exemplary embodiment, each of the first touch pad part, the first connection part CP1, the second touch pad part TP2, and the second connection part CP2 includes the transparent metal layer TM including metal mesh or silver nanowire, and as a result, the touch sensor unit TS may not be observed.

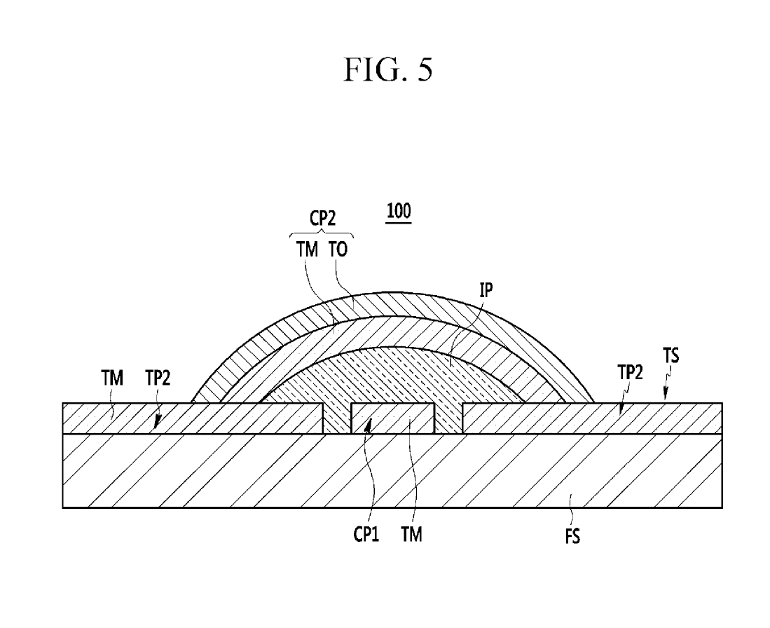

Hereinafter, a flexible touch panel according to an exemplary embodiment of the present invention will be described with reference to FIG. 5. FIG. 5 is a cross-sectional view illustrating a part of a flexible touch panel according to an exemplary embodiment of the present invention.

The second touch pad part TP2 is formed on the same layer and includes the same material as the first touch pad part and the first connection part CP1, and may be simultaneously formed with the first touch pad part and the first connection part CP1. The second touch pad part TP2 includes a transparent metal layer TM disposed on the flexible substrate FS.

The second connection part CP2 is spaced apart from the first connection part CP1 with the insulating layer IP disposed therebetween. More particularly, the second connection part CP2 is disposed on the first connection part CP1 with the insulating layer IP disposed therebetween.

The second connection part CP2 includes a transparent metal layer TM contacting the transparent metal layer TM disposed on the uppermost layer of the second touch pad part TP2 and a transparent conductive oxide layer TO disposed on the transparent metal layer TM to contact the transparent metal layer TM. The transparent metal layer TM of the second touch pad part TP2 includes metal mesh or silver nanowire, but the transparent metal layer TM of the second touch pad part TP2 contacts the transparent conductive oxide layer TO having a plate shape of the second connection part CP2, and as a result, portions of the metal mesh of the second touch pad part TP2 or silver nanowires contact the transparent conductive oxide layer TO of the second connection part CP2. As a result, contact resistance between the second connection part CP2 and the second touch pad part TP2 may be minimized.

As described above, in the flexible touch panel 100 according to the present exemplary embodiment includes the flexible substrate FS, and each of the first touch pad part, the first connection part CP1, the second touch pad part TP2, and the second connection part CP2 of the touch sensor unit TS in the flexible touch panel 100 includes the transparent metal layer TM including metal mesh or silver nanowire to improve flexibility.

Further, in the flexible touch panel 100 according to the present exemplary embodiment, each of the first touch pad part, the first connection part CP1, the second touch pad part TP2, and the second connection part CP2 includes the transparent metal layer TM including metal mesh or silver nanowire. As a result, when a stress is applied to the flexible touch panel 100 from bending the flexible touch panel 100, since metal mesh or silver nanowire may be easily bent by the stress so as to distribute the stress in the transparent metal layer TM, the touch sensor unit TS may suppress from being damaged by the stress even though each of the first touch pad part, the first connection part CP1, and the second touch pad part TP2 includes the transparent conductive oxide layer TO that has a higher brittleness than the transparent metal layer TM.

Further, in the flexible touch panel 100 according to the present exemplary embodiment, the second touch pad part TP2 includes the transparent metal layer TM including metal mesh or silver nanowire that point-contacts another contact member, but the second touch pad part TP2 contacting the second connection part CP2 includes the transparent conductive oxide layer TO having a plate shape. As a result, since portions of the metal mesh of the transparent metal layer TM of the second touch pad part TP2 or silver nanowires contact the transparent conductive oxide layer TO of the second connection part CP2, the second connection part CP2 and the second touch pad part TP2 surface-contact each other to minimize contact resistance between the second connection part CP2 and the second touch pad part TP2. Accordingly, the flexible touch panel 100 may suppress a delay of a signal passing through the touch sensor unit TS.

Further, in the flexible touch panel 100 according to the present exemplary embodiment, each of the first touch pad part, the first connection part CP1, the second touch pad part TP2, and the second connection part CP2 includes the transparent metal layer TM including metal mesh or silver nanowire, and as a result, the touch sensor unit TS may not be observed.

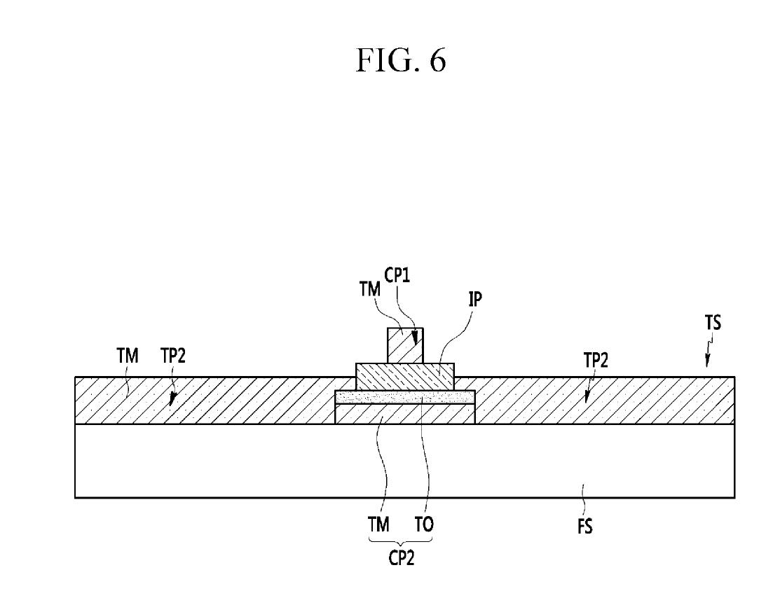

Hereinafter, a flexible touch panel according to an exemplary embodiment of the present invention will be described with reference to FIG. 6. FIG. 6 is a cross-sectional view illustrating a part of a flexible touch panel according to an exemplary embodiment of the present invention.

The second touch pad part TP2 is formed on the same layer and includes the same material as the first touch pad part and the first connection part CP1, and may be simultaneously formed with the first touch pad part and the first connection part CP1. The second touch pad part TP2 includes a transparent metal layer TM disposed on the flexible substrate FS.

The second connection part CP2 is spaced apart from the first connection part CP1 with the insulating layer IP disposed therebetween. More particularly, the second connection part CP2 is disposed below the first connection part CP1 with the insulating layer IP disposed therebetween. The insulating layer IP is disposed on the second connection part CP2, so that the first connection part CP1 and the second connection part CP2 are insulated from each other and cross each other by the insulating layer IP.

Both ends of the second connection part CP2 are covered by the second touch pad parts TP2 which are adjacent to each other, respectively, and the transparent metal layer TM of the second touch pad part TP2 contacts the transparent conductive oxide layer TO and the transparent metal layer TM of the second connection part CP2, respectively.

The second connection part CP2 includes a transparent metal layer TM contacting the transparent metal layer TM of the second touch pad part TP2 and a transparent conductive oxide layer TO disposed on the transparent metal layer TM to contact the transparent metal layer TM. The transparent metal layer TM of the second touch pad part TP2 includes metal mesh or silver nanowire, but the transparent metal layer TM of the second touch pad part TP2 contacts the transparent conductive oxide layer TO having a plate shape of the second connection part CP2, and as a result, portions of the metal mesh of the second touch pad part TP2 or silver nanowires contact the transparent conductive oxide layer TO of the second connection part CP2. As a result, contact resistance between the second connection part CP2 and the second touch pad part TP2 may be minimized.

As described above, the flexible touch panel 100 according to the present exemplary embodiment includes the flexible substrate FS, and each of the first touch pad part, the first connection part CP1, the second touch pad part TP2, and the second connection part CP2 of the touch sensor unit TS includes the transparent metal layer TM including metal mesh or silver nanowire to improve flexibility.

Further, in the flexible touch panel 100 according to the present exemplary embodiment, each of the first touch pad part, the first connection part CP1, the second touch pad part TP2, and the second connection part CP2 includes the transparent metal layer TM including metal mesh or silver nanowire. As a result, when a stress is applied to the flexible touch panel 100 from bending the flexible touch panel 100, since metal mesh or silver nanowire is easily bent by the stress so as to distribute the stress in the transparent metal layer TM, the touch sensor unit TS may be suppressed from being damaged by the stress even though each of the first touch pad part, the first connection part CP1, and the second touch pad part TP2 includes the transparent conductive oxide layer TO that has a higher brittleness than the transparent metal layer TM.

Further, in the flexible touch panel 100 according to the present exemplary embodiment, the second touch pad part TP2 includes the transparent metal layer TM including metal mesh or silver nanowire that point-contacts another contact member, but the second touch pad part TP2 contacting the second connection part CP2 includes the transparent conductive oxide layer TO having a plate shape. As a result, since portions of the metal mesh of the transparent metal layer TM of the second touch pad part TP2 or silver nanowires contact the transparent conductive oxide layer TO of the second connection part CP2, the second connection part CP2 and the second touch pad part TP2 surface-contact each other to minimize contact resistance between the second connection part CP2 and the second touch pad part TP2. As a result, the flexible touch panel 100 may suppress a delay of a signal passing through the touch sensor unit TS.

Further, in the flexible touch panel 100 according to the present exemplary embodiment, each of the first touch pad part, the first connection part CP1, the second touch pad part TP2, and the second connection part CP2 includes the transparent metal layer TM including metal mesh or silver nanowire, and as a result, the touch sensor unit TS may not be observed.

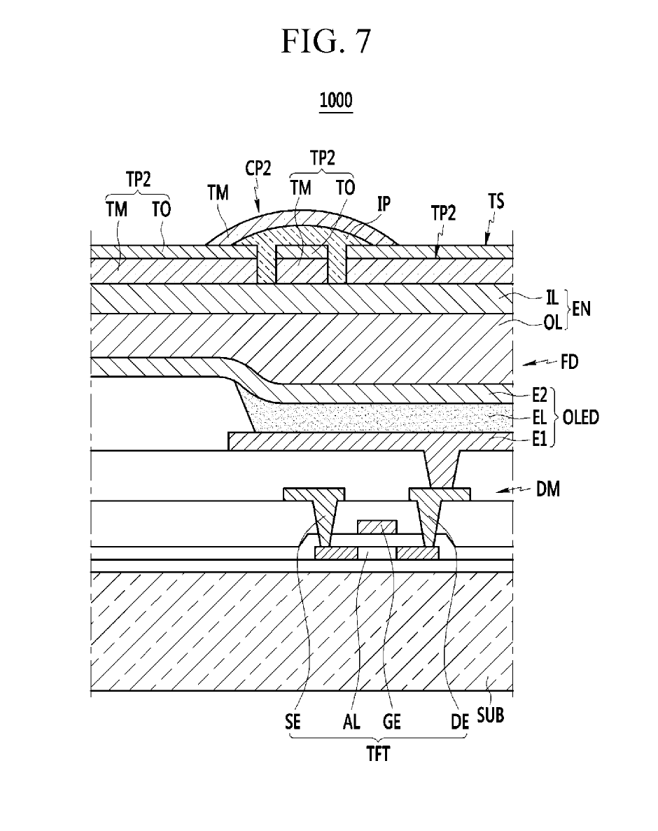

Hereinafter, a flexible display device according to an exemplary embodiment of the present invention will be described with reference to FIG. 7.

FIG. 7 is a cross-sectional view illustrating a part of a flexible display device according to an exemplary embodiment of the present invention.

As illustrated in FIG. 7, a flexible display device 1000 according to the present exemplary embodiment includes a flexible display panel FD displaying an image and a touch sensor unit TS. The flexible display panel FD includes a substrate SUB, a display unit DM, and an encapsulation part EN.

The substrate SUB is an insulation substrate including glass, polymer, stainless steel, or the like. The substrate SUB may be flexible, stretchable, foldable, bendable, or rollable, so that the entire flexible display panel FD may be flexible, stretchable, foldable, bendable, or rollable. The substrate SUB may have a flexible film shape including resin of polyimide.

The display unit DM displays an image by pixels. The pixel may be a minimum unit displaying an image. The display unit DM includes an organic light emitting diode OLED emitting light and a thin-film transistor TFT connected to the organic light emitting diode OLED. The display unit DM may further include one or more scan wires, one or more data wires, one or more thin-film transistors, and one or more capacitors in various structures.

The thin-film transistor TFT includes an active layer AL, a gate electrode GE, a source electrode SE, and a drain electrode DE.

The active layer AL may be made of polysilicon or an oxide semiconductor. The oxide semiconductor may include one of oxide based on titanium (Ti), hafnium (Hf), zirconium (Zr), aluminum (Al), tantalum (Ta), germanium (Ge), zinc (Zn), gallium (Ga), tin (Sn), or indium (In), and a complex oxide based on zinc oxide (ZnO), indium-gallium-zinc oxide (InGaZnO4), indium-zinc oxide (Zn—In—O), zinc tin oxide (Zn—Sn—O), indium-gallium oxide (In—Ga—O), indium-tin oxide (In—Sn—O), indium-zirconium oxide (In—Zr—O), indium-zirconium-zinc oxide (In—Zr—Zn—O), indium-zirconium-tin oxide (In—Zr—Sn—O), indium-zirconium-gallium oxide (In—Zr—Ga—O), indium aluminum oxide (In—Al—O), indium-zinc-aluminum oxide (In—Zn—Al—O), indium-tin-aluminum oxide (In—Sn—Al—O), indium-aluminum-gallium oxide (In—Al—Ga—O), indium-tantalum oxide (In—Ta—O), indium-tantalum-zinc oxide (In—Ta—Zn—O), indium-tantalum-tin oxide (In—Ta—Sn—O), indium-tantalum-gallium oxide (In—Ta—Ga—O), indium-germanium oxide (In—Ge—O), indium-germanium-zinc oxide (In—Ge—Zn—O), indium-germanium-tin oxide (In—Ge—Sn—O), indium-germanium-gallium oxide (In—Ge—Ga—O), titanium-indium-zinc oxide (Ti—In—Zn—O), and hafnium-indium-zinc oxide (Hf—In—Zn—O).

The active layer AL includes a channel region in which impurities are not doped, and a source region and a drain region doped with impurities and respectively disposed on each side of the channel region. The impurities may vary according to a type of thin-film transistor, and may be N-type impurities or P-type impurities. When the active layer AL is formed of the oxide semiconductor, a separate passivation layer may be added to protect the oxide semiconductor which is vulnerable to an external environment such as a high temperature,

The gate electrode GE is disposed on the active layer AL with one insulating layer disposed therebetween, and the source electrode SE and the drain electrode DE are disposed on the other insulating layer covering the gate electrode GE, respectively, to be connected with a source region and a drain region of the active layer AL through a contact hole, respectively. The drain electrode DE is connected with a first electrode E1 of the organic light emitting diode OLED through a contact hole.

The organic light emitting diode OLED includes a first electrode E1 connected to the drain electrode DE of the thin-film transistor TFT, an organic emission layer EL disposed on the first electrode E1, and a second electrode E2 disposed on the organic emission layer EL.

The first electrode E1 may be an anode which is a hole injection electrode, and may be one electrode of light-reflective, light-transflective, and light-transmissive electrodes. Alternatively, the first electrode E1 may be a cathode which is an electron injection electrode.

The organic emission layer EL is disposed on the first electrode E1. The organic emission layer EL may be made of a low-molecular organic material or a high-molecular organic material, such as poly 3,4-ethylenedioxythiophene (PEDOT). The organic emission layer EL may include a red organic emission layer emitting red light, a green organic emission layer emitting green light, and a blue organic emission layer emitting blue light. The red organic emission layer, the green organic emission layer, and the blue organic emission layer are formed in a red pixel, a green pixel, and a blue pixel, respectively, to implement a color image. In the organic emission layer EL, all of the red organic emission layer, the green organic emission layer, and the blue organic emission layer are laminated together on the red pixel, the green pixel, and the blue pixel, and a red color filter, a green color filter, and a blue color filter are formed for each pixel to implement a color image. Alternatively, white organic emission layers emitting white light as the organic emission layer EL are formed in all of the red pixel, the green pixel, and the blue pixel, and a red color filter, a green color filter, and a blue color filter are formed for each pixel to implement the color image. When implementing the color image by using the white organic emission layer as the organic emission layer EL and the color filters, a deposition mask for depositing the red organic emission layer, the green organic emission layer, and the blue organic emission layer may not be used on respective the red pixel, the green pixel, and the blue pixel. The white organic emission layer as the organic emission layer EL described above may be formed by one organic emission layer, and configured to emit white light by laminating organic emission layers. For example, the organic emission layer EL may have a configuration in which white light may emitted by combining at least one yellow organic emission layer and at least one blue light emitting layer, by combining at least one cyan organic emission layer and at least one red light emitting layer, or by combining at least one magenta organic emission layer and at least one green light emitting layer, and the like.

The second electrode E2 is disposed on the organic emission layer EL and may be a cathode which is an electron injection electrode. The second electrode E2 may be one electrode of light-reflective, light-transflective, and light-transmissive electrodes. The second electrode E2 is disposed over the entire display area DA of the substrate SUB to cover the organic emission layer EL. Alternatively, the second electrode E2 may be an anode which is a hole injection electrode.

The encapsulation part EN is disposed on the substrate SUB with the display unit DM disposed therebetween. The encapsulation part EN is disposed on the substrate SUB over the entire display area DA and a non-display area NDA of the substrate SUB and encapsulates the display unit DM together with the substrate SUB. The encapsulation part EN may be formed by a thin film encapsulation part. The encapsulation part EN includes an organic layer OL disposed on the display unit DM and an inorganic layer IL disposed on the organic layer OL. Alternatively, the encapsulation part EN may include one or more organic layers and one or more inorganic layers which are alternately laminated. More particularly, the organic layers or the inorganic layers may be in plural, respectively, and the plurality of inorganic layers and the plurality of organic layers may be alternately laminated. For example, the encapsulation part EN may include at least one sandwich structure in which at least one organic layer is inserted between at least two inorganic layers.

The organic layer OL is made of polymer, and preferably, may be a single layer of a laminated layer formed of any one of polyethylene terephthalate, polyimide, polycarbonate, epoxy, polyethylene, and polyacrylate. For example, the organic layer may be formed of polyacrylate, and includes a material in which a monomer composition including diacrylate-based monomers and triacrylate-based monomers are polymerized. The monomer composition may further include monoacrylate-based monomers and known photo-initiator, such as 2,4,6-trimethylbenzoyl-diphenyl-phosphineoxide (TPO).

The inorganic layer IL may be a single layer or a laminated layer including metal oxide or metal nitride. The inorganic layer may include one or more of silicon nitride (SiNx), aluminum oxide (Al₂O₃), silicon dioxide (SiO₂), and titanium oxide (TiO₂).

According to an exemplary embodiment of the present invention, a flexible display panel may include display devices, such as liquid crystal displays (LCDs), plasma displays (PDs), field emission displays (FEDs), electrophoretic displays (EPDs), and electrowetting displays (EWDs), as long as the display panels are flexible.

The touch sensor unit TS is formed on the encapsulation part EN of the flexible display panel FD. The touch sensor unit TS includes the first touch pad part, the first connection part CP1, the second touch pad part TP2, and the second connection part CP2 as described in exemplary embodiments of the present invention.

The second touch pad part TP2 is formed on the same layer and includes the same material as the first touch pad part TP1 and the first connection part CP1, and may be simultaneously formed with the first touch pad part TP1 and the first connection part CP1. The second touch pad part TP2 includes a transparent metal layer TM disposed on the flexible display panel FD and a transparent conductive oxide layer TO disposed on the transparent metal layer TM to contact the transparent metal layer TM.

The second connection part CP2 is spaced apart from the first connection part CP1 with the insulating layer IP disposed therebetween. More particularly, the second connection part CP2 is disposed on the first connection part CP1 with the insulating layer IP disposed therebetween.

The second connection part CP2 includes a transparent metal layer TM which contacts a transparent conductive oxide layer TO disposed on the uppermost layer of the second touch pad part TP2. The transparent metal layer TM of the second connection part CP2 includes metal mesh or silver nanowire, but the transparent metal layer TM of the second connection part CP2 contacts the transparent conductive oxide layer TO having a plate shape, and accordingly, portions of the metal mesh or silver nanowires contact the transparent conductive oxide layer TO. As a result, contact resistance between the second connection part CP2 and the second touch pad part TP2 may be minimized.

As described above, the flexible display device 1000 according to the present exemplary embodiment includes the flexible display panel FD, and each of the first touch pad part TP1 of the touch sensor unit TS, the first connection part CP1, the second touch pad part TP2, and the second connection part CP2 includes the transparent metal layer TM including metal mesh or silver nanowire to improve flexibility.

Further, in the flexible display device 1000 according to the present exemplary embodiment, each of the first touch pad part TP1, the first connection part CP1, the second touch pad part TP2, and the second connection part CP2 includes the transparent metal layer TM including metal mesh or silver nanowire. As a result, when a stress is applied to the touch sensor unit TS from bending the flexible touch panel 1000, since metal mesh or silver nanowire may be easily bent by the stress so as to distribute the stress in the transparent metal layer TM, the touch sensor unit TS may be suppressed from being damaged by the stress even though each of the first touch pad part TP1, the first connection part CP1, and the second touch pad part TP2 includes the transparent conductive oxide layer TO that has a higher brittleness than the transparent metal layer TM.

Further, in the flexible display device 1000 according to the present exemplary embodiment, the second connection part CP2 includes the transparent metal layer TM including metal mesh or silver nanowire that point-contacts another contact member, but the second touch pad part TP2 contacting the second connection part CP2 includes the transparent conductive oxide layer TO having a plate shape. As a result, since portions of the metal mesh of the transparent metal layer TM of the second connection part CP2 or silver nanowires contact the transparent conductive oxide layer TO of the second touch pad part TP2, the second connection part CP2 and the second touch pad part TP2 surface-contact each other to minimize contact resistance between the second connection part CP2 and the second touch pad part TP2. As a result, the flexible display device 1000 may suppress a delay of a signal passing through touch sensor unit TS.

Further, in the flexible display device 1000 according to the present exemplary embodiment, each of the first touch pad part TP1, the first connection part CP1, the second touch pad part TP2, and the second connection part CP2 includes the transparent metal layer TM including metal mesh or silver nanowire, and as a result, the touch sensor unit TS may not be observed. More particularly, a portion of the flexible display device 1000 in which the touch sensor unit TS overlaps image displaying area may not be viewed from outside.

Although certain exemplary embodiments and implementations have been described herein, other embodiments and modifications will be apparent from this description. Accordingly, the inventive concept is not limited to such exemplary embodiments, but rather to the broader scope of the presented claims and various obvious modifications and equivalent arrangements.

What is claimed is:

1. A flexible touch panel, comprising:
a flexible substrate; and
a touch sensor unit disposed on the flexible substrate, the touch sensor unit comprising a transparent conductive oxide layer and a transparent metal layer laminated to contact each other.

2. The flexible touch panel of claim 1, wherein the transparent metal layer comprises metal mesh.

3. The flexible touch panel of claim 1, wherein the transparent metal layer comprises silver nanowire (AgNW).

4. The flexible touch panel of claim 1, wherein the touch sensor unit further comprises:
first touch pad parts disposed on the flexible substrate, the first touch pad parts spaced apart from each other in a first direction;
a first connection part connecting the first touch pad parts;
second touch pad parts disposed on the flexible substrate, the second touch pad parts spaced apart from each other in a second direction crossing the first direction;
a second connection part connecting the second touch pad parts; and
an insulating layer disposed between and separating the first connection part and the second connection part.

5. The flexible touch panel of claim 4, wherein the first touch pad parts and the first connection part are integrally formed.

6. The flexible touch panel of claim 5, wherein the second touch pad parts are disposed on the same layer as the first touch pad parts.

7. The flexible touch panel of claim 4, wherein:
a second touch pad part comprises a first transparent metal layer disposed on the flexible substrate and a first transparent conductive oxide layer disposed on the first transparent metal layer; and
the second connection part comprises a second transparent metal layer contacting the first transparent conductive oxide layer.

8. The flexible touch panel of claim 4, wherein:
a second touch pad part comprises a first transparent conductive oxide layer disposed on the flexible substrate and a first transparent metal layer disposed on the first transparent conductive oxide layer; and
the second connection part comprises a second transparent metal layer contacting the first transparent metal layer.

9. The flexible touch panel of claim 4, wherein:
a second touch pad part comprises a first transparent metal layer disposed on the flexible substrate; and
the second connection part comprises a first transparent conductive oxide layer contacting the first transparent metal layer and a second transparent metal layer disposed on the first transparent conductive oxide layer.

10. The flexible touch panel of claim 4, wherein:
a second touch pad part comprises a first transparent metal layer disposed on the flexible substrate; and
the second connection part comprises a second transparent metal layer contacting the first transparent metal layer and a first transparent conductive oxide layer disposed on the second transparent metal layer.

11. The flexible touch panel of claim 4, wherein:
the insulating layer is disposed on the second connection part;
a second touch pad part comprises a first transparent metal layer disposed on the flexible substrate; and
the second connection part comprises a second transparent metal layer contacting the first transparent metal layer and a first transparent conductive oxide layer disposed on the second transparent metal layer.

12. A flexible display device, comprising:
a flexible display panel configured to display an image; and
a touch sensor unit disposed on the flexible display panel, the touch sensor unit comprising a transparent conductive oxide layer and a transparent metal layer laminated to contact each other.

13. The flexible touch panel of claim 7, wherein:
a first touch pad part and the first connection part comprise a third transparent metal layer and a second transparent conductive oxide layer disposed on the third transparent metal layer; and
the first connection part is spaced apart from the second touch pad part by the insulation layer.

14. The flexible touch panel of claim 8, wherein:
a first touch pad part and the first connection part comprise a second transparent conductive oxide layer and a third transparent metal layer disposed on the second transparent conductive oxide layer; and
the first connection part is spaced apart from the second touch pad part by the insulation layer.

15. The flexible touch panel of claim 9, wherein:
a first touch pad part and the first connection part comprise a third transparent metal layer disposed on the flexible substrate; and
the first connection part is spaced apart from the second touch pad part by the insulation layer.

16. The flexible touch panel of claim 10, wherein:
a first touch pad part and the first connection part comprise a third transparent metal layer disposed on the flexible substrate; and
the first connection part is spaced apart from the second touch pad part by the insulation layer.

17. The flexible touch panel of claim 11, wherein:
a first touch pad part and the first connection part comprise a third transparent metal layer disposed on the insulating layer; and
a first distance from the flexible substrate to an upper surface of the third transparent metal layer is greater than a second distance from the flexible substrate to an upper surface of the first transparent metal layer, so that the third transparent metal layer does not contact the first transparent metal layer.
